(19) United States
(12) Patent Application Publication
(10) Pub. No.: US 2024/0280710 A1
(43) Pub. Date: Aug. 22, 2024

(54) Method for Position Determination by Tracking GNSS Satellites Using Vector Tracking Loops

(71) Applicant: Robert Bosch GmbH, Stuttgart (DE)

(72) Inventors: Christian Skupin, Garbsen (DE); David Oertel, Hannover (DE); Nikolay Mikhaylov, Hildesheim (DE); Vishwanath Malipatil, Heilbronn (DE)

(21) Appl. No.: 18/582,194

(22) Filed: Feb. 20, 2024

(30) Foreign Application Priority Data
Feb. 21, 2023 (DE) 10 2023 201 525.0

(51) Int. Cl. G01S 19/49; G01S 19/47

(52) U.S. Cl. CPC G01S 19/49; G01S 19/47

(57) ABSTRACT

A method is disclosed for position determination by receiving GNSS signals using a GNSS receiver including a plurality of channels, which can be connected in a data-conducting manner to a common Kalman filter to form a plurality of vector tracking loops such that each received GNSS signal can be processed in an iterative manner using a corresponding vector tracking loop while taking into account the measurements returned by the common Kalman filter. The method includes (a) receiving GNSS signals, (b) processing a received GNSS signal using a corresponding vector tracking loop such that the information contained in the GNSS signal is determined while taking into account a virtual value, wherein the virtual value is generated such that measurements to be returned by the common Kalman filter are aggregated to this virtual value for a predefined number of iterations, (c) entering the information determined from the GNSS signal into the common Kalman filter, (d) determining the position using the common Kalman filter based on the information determined from the GNSS signal, and (e) repeating steps (a) to (d) for subsequent iterations.

This application claims priority under 35 U.S.C. § 119 to patent application no. DE 10 2023 201 525.0, filed on Feb. 21, 2023 in Germany, the disclosure of which is incorporated herein by reference in its entirety.

### BACKGROUND

The present disclosure relates to a method for position determination by tracking GNSS satellites using vector tracking loops. Also disclosed are a control device, a computer program, a machine-readable storage medium, a geolocation system for a vehicle, and a method for operating the geolocation system. The disclosure can in particular be used in GNSS-based geolocation systems for autonomous or semi-autonomous driving.

Currently, there are a variety of vector tracking (VT) approaches for tracking GNSS satellites that map to three main categories, namely frequency-based vector frequency lock loops (VFLL), code-based vector delay lock loops (VDLL), and phase-based vector phase lock loops (VPLL). Using a (virtual) base station as the reference unit, the vector tracking approaches can be extended, including, e.g., differential vector phase lock loops (DVPLL). It is also possible to extend the vector tracking approaches to hybrid systems.

Despite excellent tracking capability, especially in low signal-to-noise environments, the vector tracking approaches suffer from higher computational load compared to classical scalar tracking approaches when, e.g., classical Position Velocity Time (PVT) predictions are performed for Single Point Positioning (SPP).

In the classical scalar tracking approaches, signal tracking on a channel is typically performed at an update rate of 50 to 100 Hz, with the updating of tracking different satellite signals in different channels being performed independently of each other. This typically requires only some simple mathematical operations such as multiplication and addition. PVT prediction is additionally performed, e.g. using a Kalman filter (KF) at update rates typically from 1 to 10 Hz.

In contrast, using the vector tracking approaches, each tracking step on each channel requires a PVT or KF update. In other words, the total KF update rate can be 1 kHz if, e.g., there are 10 channels each featuring a 100 Hz update rate of tracking steps because the signal tracking of the individual channels can no longer be considered independent, whereas the scalar tracking approaches only require a KF update rate of 1 to 10 Hz. Therefore, the computational load on the vector tracking approaches increases significantly due to the increased need for KF updates.

Proceeding therefrom, the object of the present disclosure is to alleviate or at least partially solve the problems described in relation to the prior art. In particular, a method for position determination by tracking GNSS satellites using vector tracking loops is to be provided, using which a synchronous KF update for all channels is made possible, thereby reducing computational effort while maintaining tracking capability.

### SUMMARY

Contributing to this is a method for position determination by receiving GNSS signals using a GNSS receiver comprising a plurality of channels, whereby said channels can be connected in a data-conducting manner to a common Kalman filter to form a plurality of vector tracking loops such that each received GNSS signal can be processed in an iterative manner using a corresponding vector tracking loop while taking into account the measurements returned by the common Kalman filter, said method comprising the following steps:
a) receiving GNSS signals,
b) processing a received GNSS signal using a corresponding vector tracking loop such that the information contained in the GNSS signal is determined while taking into account a virtual value, whereby the virtual value is generated such that measurements to be returned or processed by the common Kalman filter are aggregated to this virtual value for a predefined number of iterations,
c) entering the information determined from the GNSS signal into the common Kalman filter,
d) determining the position using the common Kalman filter based on the information determined from the GNSS signal, and
e) repeating steps a) to d) for subsequent iterations.

Steps a), b), c), d), and e) can, e.g., be performed at least once and/or repeatedly in the specified order in order to perform the method. Steps a), b), c), and d) can furthermore be performed at least partially in parallel or simultaneously.

In particular, according to step b) and step c), a plurality of received GNSS signals, each associated with a single channel and vector tracking loop, are processed simultaneously. The position according to step d) is therefore determined based on the information determined from many (e.g., four) GNSS signals.

The method described is particularly suitable for autonomous driving. It is particularly advantageous if an autonomously driving motor vehicle comprising a geolocation system is equipped with a GNSS receiver for performing the method described.

GNSS is the abbreviation for Global Navigation Satellite Systems, e.g. GPS, GLONASS, Galileo, and Beidou. Each GNSS comprises a plurality of GNSS satellites that move in the sky or orbit according to specific ephemeris data. To determine a position in a three-dimensional space, according to step a) at least four GNSS signals from four different GNSS satellites of a GNSS can be received.

In particular, GNSS signal in this context means a signal emitted by a GNSS satellite in which a low-frequency useful signal is modulated on a high-frequency carrier.

A GNSS receiver is provided for receiving and tracking a GNSS signal, which comprises a plurality of channels, e.g. eight or twelve channels. In particular, a channel in this context means a GNSS signal processing unit configured to locally demodulate a modulated GNSS signal in order to determine the information contained in this GNSS signal, e.g. the distortion of the carrier frequency (Doppler frequency), pseudocode and navigation message. Particularly relevant to tracking a GNSS signal are the Doppler frequency and the pseudocode. These can be determined using a frequency and/or code phase based discriminator configured in a channel.

It is particularly advantageous if, according to step b), a plurality of vector tracking loops can simultaneously process a plurality of different GNSS signals to simultaneously determine the Doppler frequency, the pseudocode and the navigation message of the respective GNSS signals.

Essentially, the plurality of channels can be connected or are connected to a common Kalman filter to form a plurality of vector tracking loops in a data-conductive manner. Therefore, according to step b), each received GNSS signal with a corresponding vector tracking loop can also be processed iteratively while taking into account the measurements to be returned to this common Kalman filter, whereby the measurements can be aggregated to a virtual value for a number of iterations. It can in this case be provided that, on the one hand, the channels are connected to this common Kalman filter when entering the information determined from the GNSS signals into the common Kalman filter and, on the other hand, said common Kalman filter is coupled back to the respective channels in a data-conducting manner when the measurements are returned.

In principle, a vector tracking loop can comprise:
a generator (e.g., NCO: Numerically Controlled Oscillator) to generate a local replica,
a correlator for correlating the local replica with a currently received GNSS signal, and
a discriminator for determining the carrier frequency and/or code phase deviation of the GNSS signal.

Using vector tracking loops, it is possible that the user position information (e.g., PVT) is predicted or updated with the common Kalman filter based on the carrier frequency and/or code phase deviations of all channels in an iterative manner, time step by time step and, conversely, the Doppler frequency and/or code phase of the individual channels are also predicted or updated based on the updated user position information. This may mean that, in addition to the common Kalman filter for updating the user position information, each vector tracking loop additionally requires a Kalman filter for updating the Doppler frequency and/or code phase of the GNSS signal to be processed using this loop based on the returned user position information. Updating the Doppler frequency and/or code phase of a GNSS signal processed or to be processed using a vector tracking loop is referred to herein as a VT-KF update.

Using a single vector tracking loop, the following regular steps can, e.g., be performed in one iteration (i.e., repeated once):
i) updating the user position information at the time step k using the common Kalman filter based on the determined carrier frequency and/or code phase deviations of all channels at the time step k−1,
ii) generating a local replica at the time step k+1 such that the corresponding GNSS satellite in the field of view is predicted based on the user position information at the time step k and the ephemeris data, and thus the Doppler frequency and/or the code phase of the corresponding GNSS signal are predicted at the time step k+1,
iii) correlating the local replica at the time step k+1 with the received GNSS signal at the time step k+1
iv) determining the carrier frequency and/or code phase deviation by means of the discriminator at time step k+1,
v) updating the user position information at the time step k+1, and repeating i) to iv) for subsequent iterations.

Compared to the regular steps described hereinabove, the essential idea of the disclosure is that, according to step b), for each channel or vector tracking loop, the measurements to be returned by the common Kalman filter are aggregated to a virtual value for a predefined number of iterations. In this case, the measurements to be returned can be the discriminator values (frequency, code, and/or phase discriminator). This may mean that the measured values are not directly used by the common Kalman filter for updating the user position information at time step k and returned to the generator for generating the replica (see step ii)), but are buffered until the user position information is updated in the Kalman filter. The buffered measured values can in this case be stored in a memory and aggregated to a virtual value. This virtual value can then be returned for performing the regular steps ii) to v). During buffering, the local replica with the generator and/or the carrier frequency and/or code phase deviation with the discriminator need not necessarily be regenerated (i.e., updated). For this purpose, the most recent updated replica, and/or the most recent carrier frequency, and/or code phase deviation can, e.g., be used to update the user position information during buffering.

Aggregation can in this case be the summarization of the buffered measured values which have been updated in the last time steps (i.e., k−1, k−2, k−3, . . . ) to a common value such as the mean value/arithmetic mean. This common value is referred to herein as a virtual value. In this way, for example, the error variance caused by deviations in the individual updates to the user position information can be eliminated.

It can be provided that the measurements to be returned are aggregated to a virtual value using the following sub-steps:
1) buffering the measurements to be returned for multiple iterations, whereby these measurements can be stored in memory,
2) aggregating the buffered measurements to a virtual value,
3) entering the virtual value into a vector tracking loop,
4) emptying the memory and repeating the previous sub-steps.
The sub-steps described hereinabove are performed separately for each channel.

The number of iterations for buffering can be individually selected depending on the channel integration time. However, the greater the number, the greater the likelihood that the tracking will fail due to insufficient responsiveness to the signal dynamics. It is therefore advantageous if the number is predefined as being up to ten.

Using the aggregation of the buffered measurements being returned, the total computational load can be reduced while maintaining tracking capability.

It is preferable if, in step b), the measurements being returned are aggregated to the virtual value for two to ten iterations.

It is additionally preferable if, in step b), the virtual value is regenerated after a predefined number of iterations have been performed on the vector tracking loop.

It is particularly preferable if, in step b), the virtual value is reaggregated when the information determined from the GNSS signal reaches a predefined threshold value.

As described hereinabove, the number of iterations for buffering the measurements is a compromise between dynamic sensitivity and computational load savings. To minimize the divergence of the discriminator inputs, a monitoring module can be used to evaluate the current discriminator inputs and optionally trigger an early generation of the virtual value or an early update of the replica.

A threshold value can be predefined in this case. Once the monitoring module detects that the discriminator inputs reach the threshold value, an early generation of a virtual value for the channel associated with this discriminator or vector tracking loop triggered. In this case, the buffered measurements from the last iteration steps are aggregated to a new virtual value, although it is possible that the predefined number of iterations for aggregation has not yet been reached. It is also possible to return the current measurement directly into the channel or the vector tracking loop instead of the virtual value without buffering or aggregation (i.e. N=1).

The monitoring module can also be designed as a preselector that can define the number of iterations for buffering.

It is preferable if, in step b), the measurements to be returned are aggregated separately for each vector tracking loop for an individual number of iterations to form a virtual value. To this end, the monitoring module can individually define a number of iterations as a selector for each channel. It is in this case particularly advantageous that the channels do not necessarily have to be synchronized with one another.

As further described hereinabove, a vector tracking loop typically requires its own VT-KF update, namely the update of the Doppler frequency and/or the code phase of the GNSS signal to be tracked based on the returned PVT measurements for the local replica.

As a virtual value is individually generated for each channel in this embodiment, it is advantageous if each vector tracking loop can perform its own VT-KF update based on the corresponding virtual value.

In this embodiment, it can be provided that the measurements to be returned are aggregated to a virtual value using the following sub-steps:
1) buffering the measurements to be returned for multiple iterations for a vector tracking loop, whereby the VT-KF update of said vector tracking loop can be interrupted by maintaining the latest updated carrier frequency- and/or code phase deviation,
2) aggregating the buffered measurements to a virtual value for this vector tracking loop,
3) entering the virtual value into this vector tracking loop, whereby the own VT-KF update (i.e., prediction of Doppler frequency and/or code phase) is performed based on this virtual value,
4) inputting the predicted Doppler frequency and/or the predicted code phase into the generator (e.g., NCO) for the local replica, and
5) emptying the memory and repeating the previous sub-steps for any subsequent iteration steps.
The sub-steps described hereinabove are performed separately for each channel.

It is preferable if, in step b), the measurements to be returned for multiple vector tracking loops are aggregated to virtual values and these are processed together in the common Kalman filter. The monitoring module can in this case define a (uniform) number of iterations as a selector for all channels.

Given that the virtual values for multiple vector tracking loops are generated or available simultaneously in this embodiment, it is possible for the KF updates of all vector tracking loops to be performed at once. In this embodiment, the virtual values are transferred together with the common Kalman filter as inputs and the common Kalman filter determines the VT-KF update (i.e., prediction of Doppler frequency and/or code phase) in a single computational step for all participating channels.

In this embodiment, it can be provided that the measurements to be returned are aggregated for all channels or vector tracking loops using the following sub-steps:
1) buffering the measurements to be returned in each channel for multiple iterations, whereby the VT-KF update of each channel can be interrupted by maintaining the corresponding latest updated Doppler frequency and/or code phase,
2) aggregating the buffered measurements to a virtual value for each channel, whereby the channels that were only included in the vector tracking loops during buffering can be ignored.
3) performing the VT-KF updates of all channels,
4) generating the predicted Doppler frequency and/or code phase of all channels and entering the predicted Doppler frequency and/or code phase in the corresponding individual channels.
5) emptying the memory and repeating the preceding sub-steps.

It is preferable if, in step b), the measurements to be returned are aggregated to a virtual value according to a mean value, a median or an extreme value.

It is preferable if the information determined from the GNSS signal comprises a Doppler frequency and/or code phase.

It is preferable if the vector tracking loop is designed as a vector frequency lock loop, vector delay lock loop or vector phase lock loop.

In principle, the described method is usable for each main category of vector tracking approaches. Due to different category-specific requirements, it is particularly advantageous if the threshold value specified hereinabove and the number of iterations for buffering can be adjusted accordingly.

It is preferable if a control device for the GNSS receiver is configured to perform the described method.

It is also preferable if a computer program is used to perform a method described herein. In other words, this relates in particular to a computer program (product) comprising commands which, when the program is executed by a computer, prompt said computer to perform a method described herein.

It is also preferable if a machine-readable storage medium is used, on which the computer program proposed herein is stored. Conventionally, the machine-readable storage medium is a computer-readable data medium.

It is particularly preferable if the geolocation system for a vehicle is configured to perform a method described herein.

### BRIEF DESCRIPTION OF THE DRAWINGS

The solution presented herein and the technical environment thereof are explained in greater detail hereinafter making reference to the drawings. It should be noted that the disclosure is not intended to be limited by the exemplary embodiments disclosed. In particular, unless explicitly stated otherwise, it is also possible to extract partial aspects of the factual subject matter described in relation to the drawings and to combine them with other components and/or knowledge based on other drawings and/or the present description. Shown schematically are:

FIG. 1 a block diagram of the described method.

### DETAILED DESCRIPTION

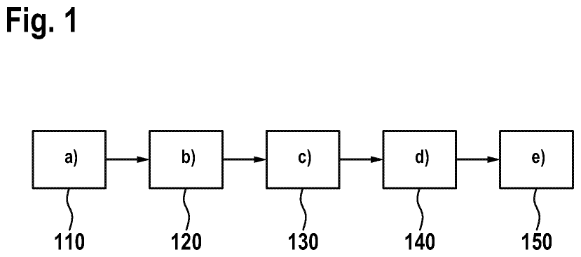

FIG. 1 schematically shows a sequence of a method presented herein for position determination by receiving GNSS signals using a GNSS receiver comprising a plurality of channels during a regular operating sequence, whereby said channels can be connected in a data-conducting manner to a common Kalman filter to form a plurality of vector tracking loops such that each received GNSS signal can be processed in an iterative manner using a corresponding vector tracking loop while taking into account the measurements returned by the common Kalman filter. The illustrated sequence of the method steps a), b), c), d), and e) with the blocks 110, 120, 130, 140, and 150 is merely exemplary. In block 110, GNSS signals are received. In block 120, a received GNSS signal is processed using a corresponding vector tracking loop such that the information contained in the GNSS signal is determined while taking into account a virtual value, whereby the virtual value is generated such that measurements to be returned by the common Kalman filter are aggregated to this virtual value for a predefined number of iterations. In block 130, the information determined from the GNSS signal is entered into the common Kalman filter. In block 140, the position is determined using the Kalman common filter based on the information determined from the GNSS signal. In the block 150, method steps a) to d) are repeated for subsequent iterations.

Using the aggregation of the buffered measurements to be returned, the total computational load can be reduced while maintaining tracking capability.

The method described is particularly suitable for autonomous driving. It is particularly advantageous if an autonomously driving motor vehicle comprising a geolocation system is equipped with a GNSS receiver for performing the method as described.

What is claimed is:

1. A method for position determination by receiving GNSS signals using a GNSS receiver comprising a plurality of channels, which can be connected in a data-conducting manner to a common Kalman filter to form a plurality of vector tracking loops such that each received GNSS signal can be processed in an iterative manner using a corresponding vector tracking loop while taking into account the measurements returned by the common Kalman filter, the method comprising:
a) receiving GNSS signals;
b) processing a received GNSS signal using a corresponding vector tracking loop such that the information contained in the GNSS signal is determined while taking into account a virtual value, wherein the virtual value is generated such that measurements to be returned by the common Kalman filter are aggregated to the virtual value for a predefined number of iterations;
c) entering the information determined from the GNSS signal into the common Kalman filter;
d) determining the position using the common Kalman filter based on the information determined from the GNSS signal; and
e) repeating steps a) to d) for subsequent iterations.

2. The method according to claim 1, wherein:
in step b), the measurements to be returned are aggregated to the virtual value for two to ten iterations.

3. The method according to claim 1, wherein:
in step b), the virtual value is regenerated after a predefined number of iterations have been performed on the vector tracking loop.

4. The method according to claim 1, wherein:
in step b), the virtual value is reaggregated when the information determined from the GNSS signal reaches a predefined threshold.

5. The method according to claim 1, wherein:
in step b), the measurements to be returned for each vector tracking loop are aggregated to a virtual value separately from one another for an individual number of iterations.

6. The method according to claim 1, wherein:
in step b), the measurements to be returned for multiple vector tracking loops are aggregated to virtual values and processed together in the common Kalman filter.

7. The method according to claim 1, wherein:
in step b), the measurements to be returned are aggregated to a virtual value according to a mean value, a median, or an extreme value.

8. The method according to claim 1, wherein the information determined from the GNSS signal comprises a Doppler frequency and/or code phase.

9. The method according to claim 1, wherein the vector tracking loop is designed as a vector frequency lock loop, vector delay lock loop, or vector phase lock loop.

10. A control device for the GNSS receiver, which device is configured to perform a method according to claim 1.

11. A computer program for performing a method according to claim 1.

12. A machine-readable storage medium on which the computer program according to claim 11 is stored.

13. A geolocation system for a vehicle, which system is configured to perform a method according to claim 1.
